(19) United States
(12) Patent Application Publication
(10) Pub. No.: US 2013/0211692 A1
(43) Pub. Date: Aug. 15, 2013

(54) AIR-FUEL RATIO CONTROL APPARATUS AND AIR-FUEL RATIO CONTROL METHOD FOR INTERNAL COMBUSTION ENGINE MOUNTED ON HYBRID VEHICLE

(71) Applicant: Yoshikazu Asami, Gotenba-shi (JP)

(72) Inventor: Yoshikazu Asami, Gotenba-shi (JP)

(21) Appl. No.: 13/755,705

(22) Filed: Jan. 31, 2013

(30) Foreign Application Priority Data
Feb. 13, 2012 (JP) 2012-028328

(51) Int. Cl. F02D 41/00

(52) U.S. Cl. CPC F02D 41/00
USPC 701/103

(57) ABSTRACT

A hybrid vehicle executes intermittent operation for stopping an operation of an internal combustion engine and thereafter resuming the operation in response to an operating state. An air-fuel ratio control apparatus executes air-fuel ratio feedback control for bringing an air-fuel ratio of air-fuel mixture supplied to the engine on the basis of an output of an upstream air-fuel ratio sensor and an output of a downstream air-fuel ratio sensor into coincidence with a target air-fuel ratio. The air-fuel ratio control apparatus acquires a catalyst parameter that indicates a state of the catalyst at a start of the engine through intermittent operation. The air-fuel ratio control apparatus substantially corrects the target air-fuel ratio in response to the acquired catalyst parameter in a predetermined period after a start of the engine through intermittent operation, and learns a sub-feedback amount that is calculated using the output of the downstream air-fuel ratio sensor.

### INCORPORATION BY REFERENCE

The disclosure of Japanese Patent Application No. 2012-028328 filed on Feb. 13, 2012 including the specification, drawings and abstract is incorporated herein by reference in its entirety.

### BACKGROUND OF THE INVENTION

1. Field of the Invention

The invention relates to an air-fuel ratio control apparatus and air-fuel ratio control method for an internal combustion engine mounted on a hybrid vehicle.

2. Description of Related Art

One of known air-fuel ratio control apparatuses for an internal combustion engine includes an upstream air-fuel ratio sensor provided at a location upstream of a catalyst arranged in an exhaust passage of the engine and a downstream air-fuel ratio sensor provided at a location downstream of the catalyst. The upstream air-fuel ratio sensor outputs an output value corresponding to an air-fuel ratio of exhaust gas at the location upstream of the catalyst (that is, an upstream air-fuel ratio). The downstream air-fuel ratio sensor outputs an output value corresponding to an air-fuel ratio of exhaust gas at the location downstream of the catalyst (that is, a downstream air-fuel ratio). This existing device executes feedback control over the air-fuel ratio of the engine on the basis of the output value of the upstream air-fuel ratio sensor and the output value of the downstream air-fuel ratio sensor such that the air-fuel ratio of air-fuel mixture that is supplied to the engine (that is, the air-fuel ratio of the engine) coincides with a target air-fuel ratio.

Incidentally, an air-fuel ratio appropriate for the catalyst to efficiently purify exhaust gas (hereinafter, also referred to as “catalyst required air-fuel ratio”) varies on the basis of, for example, an intake air flow rate of the engine and/or an engine rotation speed. Thus, for example, in the case where the intake air flow rate and/or the engine rotation speed significantly vary, emissions may deteriorate during a period until the air-fuel ratio of the engine is changed to the catalyst required air-fuel ratio through air-fuel ratio feedback control. The above-described existing device further calculates a catalyst-related correction amount on the basis of the intake air flow rate and/or the engine rotation speed such that the air-fuel ratio of exhaust gas flowing into the catalyst becomes the catalyst required air-fuel ratio and then substantially changes the target air-fuel ratio using the catalyst-related correction amount (for example, see Japanese Patent Application Publication No. 2005-48711 (JP 2005-48711 A)).

On the other hand, a hybrid vehicle includes an electric motor and an engine as driving sources that generate driving force for propelling the vehicle. One of hybrid vehicles determines an engine required power on the basis of a torque that is determined in response to a user's accelerator operation amount (that is, a user required torque that is required to rotate a drive shaft of the vehicle). In addition, the hybrid vehicle controls the engine such that the power of the engine satisfies the engine required power and the operation efficiency of the engine is optimal, and the amount of torque by which the output torque of the engine, which is transmitted to the drive shaft, is insufficient with respect to the user required torque is compensated by the output torque of the electric motor in this case.

Furthermore, when the user required torque is small (thus, the engine required power is small) and, therefore, for example, it is not possible to operate the engine at an efficiency higher than or equal to a predetermined efficiency (that is, at the time when an engine operation stop condition is satisfied), the hybrid vehicle stops the operation of the engine and fulfills the user required torque by using only the output torque of the electric motor. Moreover, when the user required torque increases (thus, the engine required power increases) in a state where the operation of the engine is stopped and, therefore, for example, it is possible to operate the engine at an efficiency higher than or equal to the predetermined efficiency (that is, at the time when an engine start condition is satisfied), the hybrid vehicle starts the engine and fulfills the user required torque by using the output torque of the engine and the output torque of the electric motor. Such an operation to stop and start the operation of the engine based on the operating state of the hybrid vehicle is intermittently executed, so the operation is called intermittent operation or engine intermittent operation (for example, see Japanese Patent Application Publication No. 9-308012 (JP 9-308012 A)).

On the other hand, the catalyst required air-fuel ratio also varies depending on a temperature and/or oxygen storage amount, or the like, of the catalyst. By so doing, when the engine that employs the above-described air-fuel ratio control apparatus is mounted on the hybrid vehicle, the air-fuel ratio of exhaust gas flowing into the catalyst after a start of the engine through intermittent operation deviates from the catalyst required air-fuel ratio and, as a result, emissions may deteriorate.

That is, when the operation of the engine is stopped through intermittent operation, the catalyst temperature decreases due to, for example, a travelling wind of the vehicle. The degree of decrease in the catalyst temperature varies depending on an operation stop time of the engine through intermittent operation. Furthermore, for example, in the case where a load of the engine is high (the intake air flow rate is large) before an operation stop of the engine due to intermittent operation and the operation stop time of the engine through intermittent operation is short, the catalyst temperature may be higher than the intake air flow rate (or load) after a start of the engine through intermittent operation. Thus, when the catalyst-related correction amount is calculated simply on the basis of the intake air flow rate and/or the engine rotation speed after a start of the engine through intermittent operation, the air-fuel ratio of exhaust gas flowing into the catalyst deviates from the catalyst required air-fuel ratio.

In addition, depending on, for example, the timing of fuel cut and/or a disturbance of the air-fuel ratio of exhaust gas at the time when the operation of the engine is stopped through intermittent operation, the oxygen storage amount of the catalyst (catalyst atmosphere) during a stop of the operation of the engine through intermittent operation varies. Thus, the catalyst required air-fuel ratio after a start of the engine through intermittent operation may vary through intermittent operation even if the catalyst temperature remains unchanged.

### SUMMARY OF THE INVENTION

The invention provides an air-fuel ratio control apparatus and an air-fuel ratio control method that improves emissions by optimizing an air-fuel ratio of an internal combustion engine, mounted on a hybrid vehicle in which intermittent operation is executed, on the basis of a catalyst state immediately after a start of the engine through the intermittent operation and, by so doing, bringing the air-fuel ratio of exhaust gas flowing into a catalyst after a start of the engine through the intermittent operation close to a catalyst required air-fuel ratio.

An aspect of the invention provides an air-fuel ratio control apparatus for an internal combustion engine, which is applied to the internal combustion engine mounted on a hybrid vehicle as a driving source together with an electric motor. The air-fuel ratio control apparatus controls an air-fuel ratio of air-fuel mixture that is supplied to the internal combustion engine (an air-fuel ratio of the engine). The engine includes a catalyst in its exhaust passage, and stops and starts its operation in response to an operating state of the hybrid vehicle.

The air-fuel ratio control apparatus further includes: an upstream air-fuel ratio sensor configured to generate an output corresponding to an air-fuel ratio of exhaust gas flowing into the catalyst; a downstream air-fuel ratio sensor configured to generate an output corresponding to an air-fuel ratio of exhaust gas flowing out from the catalyst; a feedback control unit configured to execute air-fuel ratio feedback control; and an air-fuel ratio changing unit configured to change an air-fuel ratio of exhaust gas flowing into the catalyst.

The air-fuel ratio feedback control that is executed by the feedback control unit is control for adjusting the air-fuel ratio of the engine on the basis of the output of the upstream air-fuel ratio sensor and the output of the downstream air-fuel ratio sensor such that the air-fuel ratio of air-fuel mixture that is supplied to the internal combustion engine (the air-fuel ratio of the engine) coincides with a target air-fuel ratio.

The air-fuel ratio changing unit acquires a catalyst parameter that indicates a state of the catalyst at the time point at which the internal combustion engine is started after the operation of the engine is stopped in response to the operating state of the hybrid vehicle, and changes the target air-fuel ratio on the basis of the acquired catalyst parameter in a predetermined period after the time point at which the internal combustion engine is started. By so doing, the air-fuel ratio changing unit changes the air-fuel ratio of exhaust gas flowing into the catalyst in response to the state of the catalyst at the time of a start of the internal combustion engine through intermittent operation.

There are various methods by which the air-fuel ratio changing unit changes the target air-fuel ratio. For example, one of the methods is to change the target air-fuel ratio in air-fuel ratio feedback control on the basis of the acquired catalyst parameter. Another one of the methods is to change the target air-fuel ratio in air-fuel ratio feedback control by changing the output of the upstream air-fuel ratio sensor (or an upstream air-fuel ratio indicated by the output of the upstream air-fuel ratio sensor) on the basis of the acquired catalyst parameter.

According to the aspect of the invention, when the operation of the engine is stopped through intermittent operation and, after that, the internal combustion engine is started, the state of the catalyst (for example, catalyst temperature and/or oxygen storage amount, or the like) at the time of a start of the internal combustion engine is incorporated into air-fuel ratio control in the predetermined period thereafter. Thus, when the operation of the internal combustion engine is stopped through intermittent operation and, after that, the internal combustion engine is started, after this time point, it is possible to bring the air-fuel ratio of exhaust gas flowing into the catalyst close to the catalyst required air-fuel ratio. As a result, it is possible to improve emissions.

In the aspect of the invention, the feedback control unit may be configured to calculate a target air-fuel ratio correction amount on the basis of the output of the downstream air-fuel ratio sensor such that the output of the downstream air-fuel ratio sensor coincides with a downstream target value, the feedback control unit may be configured to correct the target air-fuel ratio on the basis of the target air-fuel ratio correction amount, the feedback control unit may be configured to execute the air-fuel ratio feedback control by controlling the air-fuel ratio of the internal combustion engine such that an upstream air-fuel ratio indicated by the output of the upstream air-fuel ratio sensor coincides with the corrected target air-fuel ratio, the feedback control unit may be configured to acquire a learned value by learning the target air-fuel ratio correction amount, the feedback control unit may be configured to use a value based on the learned value as the target air-fuel ratio correction amount for correcting the target air-fuel ratio in a period during which the target air-fuel ratio correction amount cannot be updated on the basis of the output of the downstream air-fuel ratio sensor, and the air-fuel ratio changing unit may be configured to correct the target air-fuel ratio on the basis of the acquired catalyst parameter.

When the air-fuel ratio of exhaust gas flowing into the catalyst significantly deviates from the catalyst required air-fuel ratio immediately after the internal combustion engine is started through intermittent operation, a difference between the output of the downstream air-fuel ratio sensor and the downstream target value increases, so the target air-fuel ratio correction amount that is calculated on the basis of the output of the downstream air-fuel ratio sensor is varied transiently by a large amount. Thus, when a learned value is acquired by learning the thus varied target air-fuel ratio correction amount, the learned value significantly differs from a learned value in the case where the target air-fuel ratio correction amount is learned in the case where the state of the catalyst is stable (for example, the case where a catalyst temperature is sufficiently high). Therefore, for a while after the time point at which the engine is started through intermittent operation, learning the target air-fuel ratio correction amount has to be prohibited, and, as a result, the opportunity of learning reduces.

In contrast to this, according to the aspect of the invention, the target air-fuel ratio is corrected on the basis of the acquired catalyst parameter (that is, the state of the catalyst at the time of a start of the engine through intermittent operation) immediately after the start of the engine through intermittent operation. Thus, it is less likely that the target air-fuel ratio correction amount that is calculated on the basis of the output of the downstream air-fuel ratio sensor significantly deviates from the target air-fuel ratio correction amount in the case where the state of the catalyst is stable. Thus, even when learning is started after the time point at which the engine is started through intermittent operation, the learned value becomes a value close to an appropriate value. As a result, the opportunity of learning does not reduce, so it is possible to early acquire an appropriate learned value.

In the aspect of the invention, the feedback control unit may be configured to calculate a sensor output correction amount on the basis of the output of the downstream air-fuel ratio sensor such that the output of the downstream air-fuel ratio sensor coincides with a downstream target value, the feedback control unit may be configured to acquire an upstream control air-fuel ratio on the basis of the sensor output correction amount and the output of the upstream air-fuel ratio sensor, the feedback control unit may be configured to execute the air-fuel ratio feedback control by controlling the air-fuel ratio of the internal combustion engine such that the upstream control air-fuel ratio coincides with the target air-fuel ratio, the feedback control unit may be configured to acquire a learned value by learning the sensor output correction amount, the feedback control unit may be configured to use a value based on the learned value as the sensor output correction amount for acquiring the upstream control air-fuel ratio in a period during which a condition that the sensor output correction amount cannot be updated on the basis of the output of the downstream air-fuel ratio sensor is satisfied, and the air-fuel ratio changing unit may be configured to change the target air-fuel ratio by correcting the upstream control air-fuel ratio on the basis of the acquired catalyst parameter.

When the air-fuel ratio of exhaust gas flowing into the catalyst significantly deviates from the catalyst required air-fuel ratio immediately after the engine is started through intermittent operation, a difference between the output of the downstream air-fuel ratio sensor and the downstream target value increases, so the sensor output correction amount that is calculated on the basis of the output of the downstream air-fuel ratio sensor is varied transiently by a large amount. Thus, when a learned value is acquired by learning the thus varied sensor output correction amount, the learned value significantly differs from a learned value in the case where the sensor output correction amount is learned in the case where the state of the catalyst is stable. Therefore, for a while after the time point at which the engine is started through intermittent operation, learning the sensor output correction amount has to be prohibited, and, as a result, the opportunity of learning is reduced.

In contrast to this, according to the above aspect of the invention, the target air-fuel ratio is changed by correcting the upstream control air-fuel ratio on the basis of the acquired catalyst parameter (that is, the state of the catalyst at the time of a start of the engine through intermittent operation) immediately after the start of the engine through intermittent operation. Thus, it is less likely that the sensor output correction amount that is calculated on the basis of the output of the downstream air-fuel ratio sensor significantly deviates from the sensor output correction amount in the case where the state of the catalyst is stable. Thus, even when learning is started after the time point at which the internal combustion engine is started through intermittent operation, the learned value becomes a value close to an appropriate value. As a result, the opportunity of learning does not reduce, so it is possible to early acquire an appropriate learned value.

Another aspect of the invention provides an air-fuel ratio control method for air-fuel mixture that is supplied to an internal combustion engine, the internal combustion engine being mounted on a hybrid vehicle as a driving source together with an electric motor, the internal combustion engine including a catalyst in an exhaust passage, the internal combustion engine intermittently repeating a stop and start of its operation in response to an operating state of the hybrid vehicle. The air-fuel ratio control method includes: generating an output of an upstream air-fuel ratio corresponding to an air-fuel ratio of exhaust gas flowing into the catalyst; generating an output of a downstream air-fuel ratio corresponding to an air-fuel ratio of exhaust gas flowing out from the catalyst; executing feedback control over an air-fuel ratio of the internal combustion engine on the basis of the output of the upstream air-fuel ratio and the output of the downstream air-fuel ratio such that the air-fuel ratio of air-mixture supplied to the internal combustion engine coincides with a target air-fuel ratio; acquiring a catalyst parameter that indicates a state of the catalyst at the time point at which the internal combustion engine is started after the operation of the internal combustion engine is stopped in response to the operating state of the hybrid vehicle; and changing the air-fuel ratio of exhaust gas flowing into the catalyst by changing the target air-fuel ratio on the basis of an acquired catalyst parameter in a predetermined period after the time point at which the internal combustion engine is started.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view of a hybrid vehicle that includes an internal combustion engine to which an air-fuel ratio control apparatus according to a first embodiment of the invention is applied;

FIG. 2 is a graph (look-up table) that shows the correlation between an output value of an upstream air-fuel ratio sensor shown in FIG. 1 and an upstream air-fuel ratio;

FIG. 3 is a graph that shows the correlation between an output value of a downstream air-fuel ratio sensor shown in FIG. 1 and a downstream air-fuel ratio;

FIG. 4 is a flowchart that shows a routine that is executed by a CPU of a power management ECU shown in FIG. 1;

FIG. 5 is a flowchart that shows a routine that is executed by a CPU of an engine ECU shown in FIG. 1;

FIG. 6 is a flowchart that shows a routine that is executed by the CPU of the engine ECU shown in FIG. 1;

FIG. 7 is a flowchart that shows a routine that is executed by the CPU of the engine ECU shown in FIG. 1;

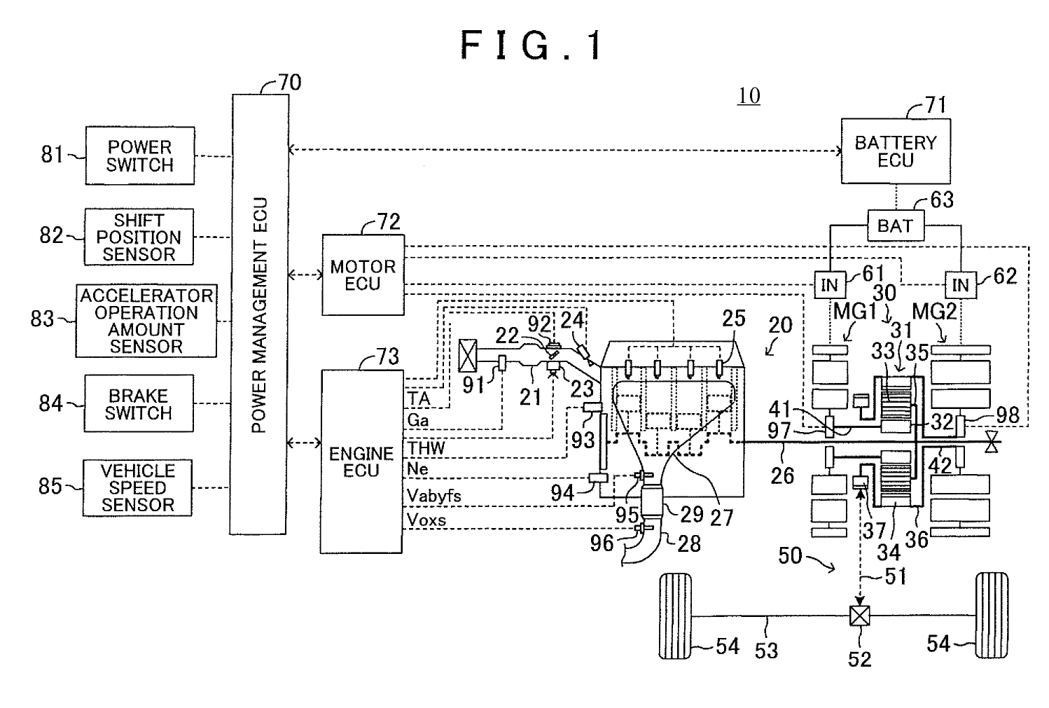

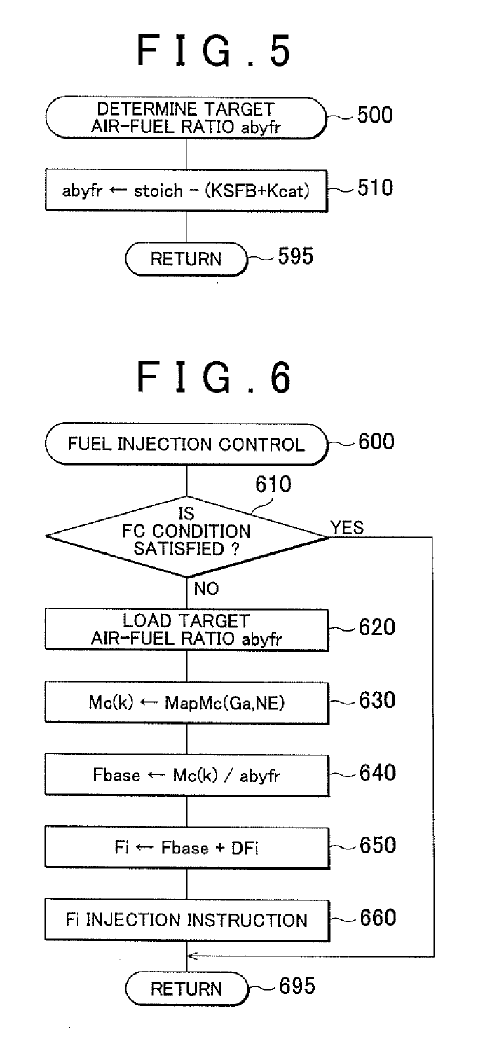

FIG. 5 is a flowchart that shows a routine that is executed by the CPU of the engine ECU shown in FIG. 1;

FIG. 9 is a flowchart that shows a routine that is executed by the CPU of the engine ECU shown in FIG. 1; and

FIG. 10 is a flowchart that shows a routine executed by a CPU of an engine ECU of an air-fuel ratio control apparatus according to a second embodiment of the invention.

### DETAILED DESCRIPTION OF EMBODIMENTS

Hereinafter, air-fuel ratio control apparatuses for an internal combustion engine according to embodiments of the invention will be described with reference to the accompanying drawings.

### First Embodiment

### Configuration

An air-fuel ratio control apparatus (hereinafter, referred to as “first device”) according to a first embodiment of the invention is applied to an internal combustion engine 20 mounted on a hybrid vehicle 10 shown in FIG. 1.

In addition to the engine 20, the hybrid vehicle 10 includes a first motor generator MG1, a second motor generator MG2, a power distribution mechanism 30, a driving force transmission mechanism 50, a first inverter 61, a second inverter 62, a battery 63, a power management ECU 70, a battery ECU 71, a motor ECU 72, an engine ECU 73, and the like.

The word “ECU” is an abbreviation of electronic control unit, and is an electronic control circuit that has a microcomputer as a major component. The microcomputer includes a CPU, a ROM, a RAM, a backup RAM (or a nonvolatile memory), an interface, and the like. The backup RAM is able to hold data irrespective of whether an ignition key switch (not shown) of the vehicle 10 is in an on state or in an off state.

The first motor generator (motor generator) MG1 is a synchronous motor generator that functions as not only a generator but also an electric motor. The first motor generator MG1 mainly functions as a generator in the present embodiment. The first motor generator MG1 includes a first shaft 41 that serves as an output shaft.

The second motor generator (motor generator) MG2, as well as the first motor generator MG1, is a synchronous motor generator that functions as not only a generator but also an electric motor. The second motor generator MG2 mainly functions as an electric motor in the present embodiment. The second motor generator MG2 includes a second shaft 42 that serves as an output shaft.

The engine 20 is a four-cycle spark-ignition multi-cylinder internal combustion engine. The engine 20 includes an intake passage unit 21, a throttle valve 22, a throttle valve actuator 23, a plurality of fuel injection valves 24, a plurality of ignition devices 25, a crankshaft 26, an exhaust manifold 27, an exhaust pipe 28 and an upstream catalyst 29. The intake passage unit 21 includes an intake pipe and an intake manifold. The plurality of ignition devices 25 each include an ignition plug. The crankshaft 26 is the output shaft of the engine 20. The exhaust pipe 28 is coupled to the exhaust manifold 27. Note that the engine 20 includes a variable intake valve timing control device (VVT) (not shown) and a downstream catalyst (not shown).

The throttle valve 22 is rotatably supported in the intake passage unit 21. The throttle valve actuator 23 changes the passage cross-sectional area of the intake passage unit 21 by rotating the throttle valve 22 in response to an instruction signal from the engine ECU 73.

Each of the plurality of fuel injection valves 24 is arranged in a corresponding one of intake ports that respectively communicate with combustion chambers. Each fuel injection valve 24 injects fuel of an instructed fuel injection amount Fi into the corresponding intake port in response to a fuel injection instruction signal. The instructed fuel injection amount Fi is included in the fuel injection instruction signal.

Each of the plurality of ignition devices 25 is configured to generate ignition spark in the combustion chamber of a corresponding one of the cylinders at predetermined timing in response to an instruction signal from the engine ECU 73.

The upstream catalyst (catalytic converter) 29 is a three-way catalyst. The catalyst 29 is arranged at an exhaust gas collecting portion of the exhaust manifold 27. That is, the catalyst 29 is provided in an exhaust passage of the engine 20. The catalyst 29 includes a known oxygen storage function, and purifies unburned substances (HC, CO, and the like) and NOx that are emitted from the engine 20.

The engine 20 changes the output torque and engine rotation speed (thus, engine power) of the engine 20 by, for example, changing the intake air flow rate through changing the opening degree of the throttle valve 22 with the use of the throttle valve actuator 23 and changing the instructed fuel injection amount Fi.

The power distribution mechanism 30 includes a known planetary gear unit 31. The planetary gear unit 31 includes a sun gear 32, a plurality of planetary gears 33 and a ring gear 34.

The sun gear 32 is connected to the first shaft 41 of the first motor generator MG1. Thus, the first motor generator MG1 is able to output torque to the sun gear 32. Furthermore, the first motor generator MG1 can be driven for rotation by torque that is input from the sun gear 32 to the first motor generator MG1 (first shaft 41). The first motor generator MG1 generates electric power as the first motor generator MG1 is driven for rotation by torque that is input from the sun gear 32 to the first motor generator MG1.

Each of the plurality of planetary gears 33 is in mesh with the sun gear 32 and is in mesh with the ring gear 34. A rotary shaft (rotation shaft) of each planetary gear 33 is provided on a planetary carrier 35. The planetary carrier 35 is retained so as to be rotatable coaxially with the sun gear 32. Thus, each planetary gear 33 revolves around the sun gear 32 while rotating around its axis. The planetary carrier 35 is connected to the crankshaft 26 of the engine 20. Thus, each planetary gear 33 can be driven for rotation by torque that is input from the crankshaft 26 to the planetary carrier 35.

The ring gear 34 is retained so as to rotate coaxially with the sun gear 32.

As described above, each planetary gear 33 is in mesh with the sun gear 32 and the ring gear 34. Thus, when torque is input from the planetary gears 33 to the sun gear 32, the sun gear 32 is driven for rotation by the torque. When torque is input from the planetary gears 33 to the ring gear 34, the ring gear 34 is driven for rotation by the torque. Conversely, when torque is input from the sun gear 32 to the planetary gears 33, the planetary gears 33 are driven for rotation by the torque. When torque is input from the ring gear 34 to the planetary gears 33, the planetary gears 33 are driven for rotation by the torque.

The ring gear 34 is connected to the second shaft 42 of the second motor generator MG2 via a ring gear carrier 36. Thus, the second motor generator MG2 is able to output torque to the ring gear 34. Furthermore, the second motor generator MG2 can be driven for rotation by torque that is input from the ring gear 34 to the second motor generator MG2 (second shaft 42). Furthermore, the second motor generator MG2 generates electric power as the second motor generator MG2 is driven for rotation by torque that is input from the ring gear 34 to the second motor generator MG2.

Furthermore, the ring gear 34 is connected to an output gear 37 via the ring gear carrier 36. Thus, the output gear 37 can be driven for rotation by torque that is input from the ring gear 34 to the output gear 37. The ring gear 34 can be driven for rotation by torque that is input from the output gear 37 to the ring gear 34.

The driving force transmission mechanism 50 includes a gear train 51, a differential gear 52 and a drive shaft 53.

The gear train 51 couples the output gear 37 to the differential gear 52 by a gear mechanism such that power is transmittable. The differential gear 52 is connected to the drive shaft 53. Drive wheels 54 are respectively connected to both ends of the drive shaft 53. Thus, torque from the output gear 37 is transmitted to the drive wheels 54 via the gear train 51, the differential gear 52 and the drive shaft 53. The hybrid vehicle 10 is able to travel by using the torque transmitted to the drive wheels 54.

The first inverter 61 is electrically connected to the first motor generator MG1 and the battery 63. Thus, when the first motor generator MG1 is generating electric power, electric power generated by the first motor generator MG1 is supplied to the battery 63 via the first inverter 61. Conversely, the first motor generator MG1 is driven for rotation by electric power that is supplied from the battery 63 via the first inverter 61.

The second inverter 62 is electrically connected to the second motor generator MG2 and the battery 63. Thus, the second motor generator MG2 is driven for rotation by electric power that is supplied from the battery 63 via the second inverter 62. Conversely, when the second motor generator MG2 is generating electric power, electric power generated by the second motor generator MG2 is supplied to the battery 63 via the second inverter 62.

Note that it is possible to directly supply electric power, which is generated by the first motor generator MG1, to the second motor generator MG2, and it is possible to directly supply electric power, which is generated by the second motor generator MG2, to the first motor generator MG1.

The battery 63 is a lithium ion battery in the present embodiment. However, the battery 63 just needs to be a chargeable and dischargeable electrical storage device, and may be a nickel metal hydride battery or another secondary battery.

The power management ECU 70 (hereinafter, referred to as “PMECU 70”) is connected to the battery ECU 71, the motor ECU 72 and the engine ECU 73 so as to be able to exchange information with them through communication.

The PMECU 70 is connected to a power switch 81, a shift position sensor 82, an accelerator operation amount sensor 83, a brake switch 84, a vehicle speed sensor 85, and the like, and receives output signals that are generated by these sensors.

The power switch 81 is a system start-up switch of the hybrid vehicle 10. The PMECU 70 is configured to start up the system (make the system enter a ready-on state) when a vehicle key (not shown) is inserted into a key slot (not shown) and the power switch 81 is operated while a brake pedal (not shown) is depressed.

The shift position sensor 82 generates a signal that indicates a shift position selected by a shift lever (not shown) that is provided near a user seat of the hybrid vehicle 10 so as to be operational by a user. The shift position includes P (parking position), R (reverse position), N (neutral position) and D (driving position).

The accelerator operation amount sensor 83 generates an output signal that indicates an operation amount (accelerator operation amount AP) of an accelerator pedal (not shown) provided so as to be operational by the user. The accelerator operation amount AP may be referred to as acceleration operation amount. The brake switch 84 generates an output signal that indicates that the brake pedal (not shown) is in an operated state when the brake pedal provided so as to be operational by the user is operated. The vehicle speed sensor 85 generates an output signal that indicates a vehicle speed SPD of the hybrid vehicle 10.

The PMECU 70 receives a remaining level (state of charge) SOC of the battery 63, which is calculated by the battery ECU 71. The remaining level SOC is calculated by a known method on the basis of, for example, an accumulated value of current flowing into or flowing out from the battery 63.

The PMECU 70 receives a signal that indicates a rotation speed of the first motor generator MG1 and a signal that indicates a rotation speed of the second motor generator MG2 via the motor ECU 72. The signal that indicates the rotation speed of the first motor generator MG1 is referred to as “MG1 rotation speed Nm1”. The signal that indicates the rotation speed of the second motor generator MG2 is referred to as “MG2 rotation speed Nm2”.

The MG1 rotation speed Nm1 is calculated by the motor ECU 72 on the basis of an output value of a resolver 97. The resolver 97 is provided for the first motor generator MG1, and outputs an output value corresponding to a rotation angle of a rotor of the first motor generator MG1. Similarly, the MG2 rotation speed Nm2 is calculated by the motor ECU 72 on the basis of an output value of a resolver 98. The resolver 98 is provided for the second motor generator MG2, and outputs an output value corresponding to a rotation angle of a rotor of the second motor generator MG2.

The PMECU 70 receives various output signals that indicate an engine state via the engine ECU 73. The output signals that indicate an engine state include an engine rotation speed Ne, a throttle valve opening degree TA, an engine coolant temperature THW, and the like.

The motor ECU 72 is connected to the first inverter 61 and the second inverter 62. The motor ECU 72 transmits instruction signals to the first inverter 61 and the second inverter 62 on the basis of commands (MG1 command torque Tm1* and MG2 command torque Tm2*) from the PMECU 70. By so doing, the motor ECU 72 controls the first motor generator MG1 with the use of the first inverter 61, and controls the second motor generator MG2 with the use of the second inverter 62.

The engine ECU 73 is connected to the throttle valve actuator 23, the fuel injection valves 24, the ignition devices 25, and the like, which serve as engine actuators, and transmits instruction signals to these actuators. Furthermore, the engine ECU 73 is connected to the air flow meter 91, a throttle valve opening degree sensor 92, a coolant temperature sensor 93, an engine rotation speed sensor 94, an upstream air-fuel ratio sensor 95, a downstream air-fuel ratio sensor 96, and the like, and acquires output signals that are generated by these sensors.

The air flow meter 91 measures the amount of air that is taken into the engine 20 per unit time, and outputs a signal that indicates the amount of air (intake air flow rate) Ga. The throttle valve opening degree sensor 92 detects the opening degree of the throttle valve 22 (throttle valve opening degree), and outputs a signal that indicates the detected throttle valve opening degree TA. The coolant temperature sensor 93 detects the temperature of coolant of the engine 20, and outputs a signal that indicates the detected coolant temperature THW.

The engine rotation speed sensor 94 generates a pulse signal each time the crankshaft 26 of the engine 20 rotates a predetermined angle. The engine ECU 73 acquires the engine rotation speed Ne on the basis of the pulse signal.

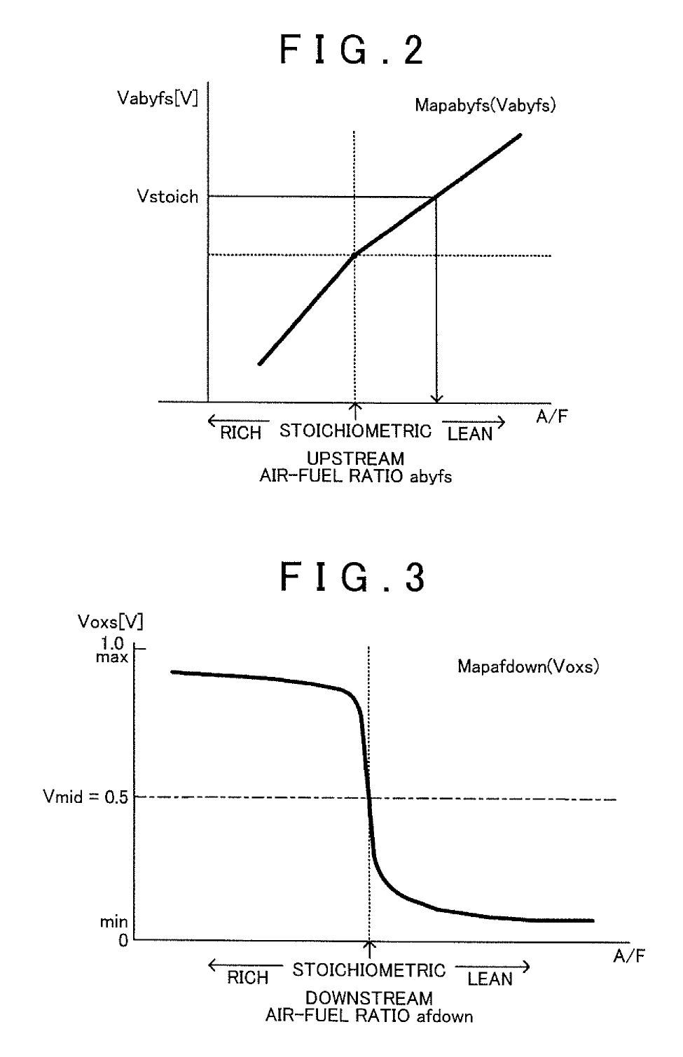

The upstream air-fuel ratio sensor 95 is arranged at the exhaust gas collecting portion of the exhaust manifold 27, and is arranged at a location upstream of the catalyst 29. The upstream air-fuel ratio sensor 95 is a so-called limiting current wide-range air-fuel ratio sensor. The upstream air-fuel ratio sensor 95 detects the air-fuel ratio of exhaust gas that passes through a location at which the upstream air-fuel ratio sensor 95 is arranged (that is, the air-fuel ratio of exhaust gas flowing into the catalyst 29), and, as shown in FIG. 2, outputs an output value Vabyfs based on the detected air-fuel ratio (upstream air-fuel ratio abyfs) of exhaust gas.

The output value Vabyfs increases as the upstream air-fuel ratio abyfs increases (becomes leaner). The engine ECU 73 acquires the detected upstream air-fuel ratio abyfs by applying the output value Vabyfs to a look-up table Mapabyfs(Vabyfs) shown in FIG. 2.

Referring back to FIG. 1, the downstream air-fuel ratio sensor 96 is arranged in the exhaust pipe 28 that is connected to the exhaust gas collecting portion of the exhaust manifold 27. A location at which the downstream air-fuel ratio sensor 96 is arranged is downstream of the catalyst 29 and upstream of a downstream catalyst (not shown) (that is, the exhaust passage between the catalyst 29 and the downstream catalyst). The downstream air-fuel ratio sensor 96 is a known electromotive force type oxygen concentration sensor. The downstream air-fuel ratio sensor 96 detects the air-fuel ratio of exhaust gas that passes through a location at which the downstream air-fuel ratio sensor 96 is arranged (that is, the air-fuel ratio of exhaust gas flowing out from the catalyst 29), and, as shown in FIG. 3, outputs an output value Voxs based on the detected air-fuel ratio (downstream air-fuel ratio) afdown of exhaust gas.

The output value Voxs becomes a maximum output value max (for example, about 0.9 V to 1.0 V) when the downstream air-fuel ratio afdown is richer than a stoichiometric air-fuel ratio. The output value Vabyfs becomes a minimum output value min (for example, about 0.1 V to 0 V) when the downstream air-fuel ratio afdown is leaner than the stoichiometric air-fuel ratio. Furthermore, the output value Voxs becomes a voltage Vmid (middle voltage Vmid, for example, about 0.5 V) that is substantially middle between the maximum output value max and the minimum output value min when the downstream air-fuel ratio afdown is the stoichiometric air-fuel ratio. The output value Voxs steeply varies from the maximum output value max to the minimum output value min when the downstream air-fuel ratio afdown varies from an air-fuel ratio richer than the stoichiometric air-fuel ratio to an air-fuel ratio leaner than the stoichiometric air-fuel ratio. Similarly, the output value Voxs steeply varies from the minimum output value min to the maximum output value max when the downstream air-fuel ratio afdown varies from an air-fuel ratio leaner than the stoichiometric air-fuel ratio to an air-fuel ratio richer than the stoichiometric air-fuel ratio.

The engine ECU 73 controls the engine 20 by transmitting instruction signals to the throttle valve actuator 2e, the fuel injection valves 24 and the ignition devices 25 (in addition, the variable intake valve timing control device (not shown)) on the basis of signals that are acquired from the above-described sensors, and the like, and commands from the PMECU 70. Note that the engine 20 is provided with a cam position sensor (not shown). The engine ECU 73 acquires a crank angle (absolute crank angle) of the engine 20 with reference to an intake top dead center of a specified cylinder on the basis of signals from the engine rotation speed sensor 94 and the cam position sensor.

### Operation: Driving Force Control

Next, the operation of the first device will be described. Note that the process described below is executed by the CPU of the PMECU 70 and the CPU of the engine ECU 73. However, in the following description, for the sake of simple description, the CPU of the PMECU 70 is referred to as “PM”, and the CPU of the engine ECU 73 is referred to as “EG”.

The PM and the EG control the engine 20, the first motor generator MG1 and the second motor generator MG2 in association with one another in order to propel the hybrid vehicle 10. The control is known and is, for example, described in detail in Japanese Patent Application Publication No. 2009-126450 (JP 2009-126450 A) (US 2010/0241297 A), Japanese Patent Application Publication No. 9-308012 (JP 9-308012 A) (U.S. Pat. No. 6,131,680 filed on Mar. 10, 1997), and the like. These are incorporated into the specification of the present application by reference.

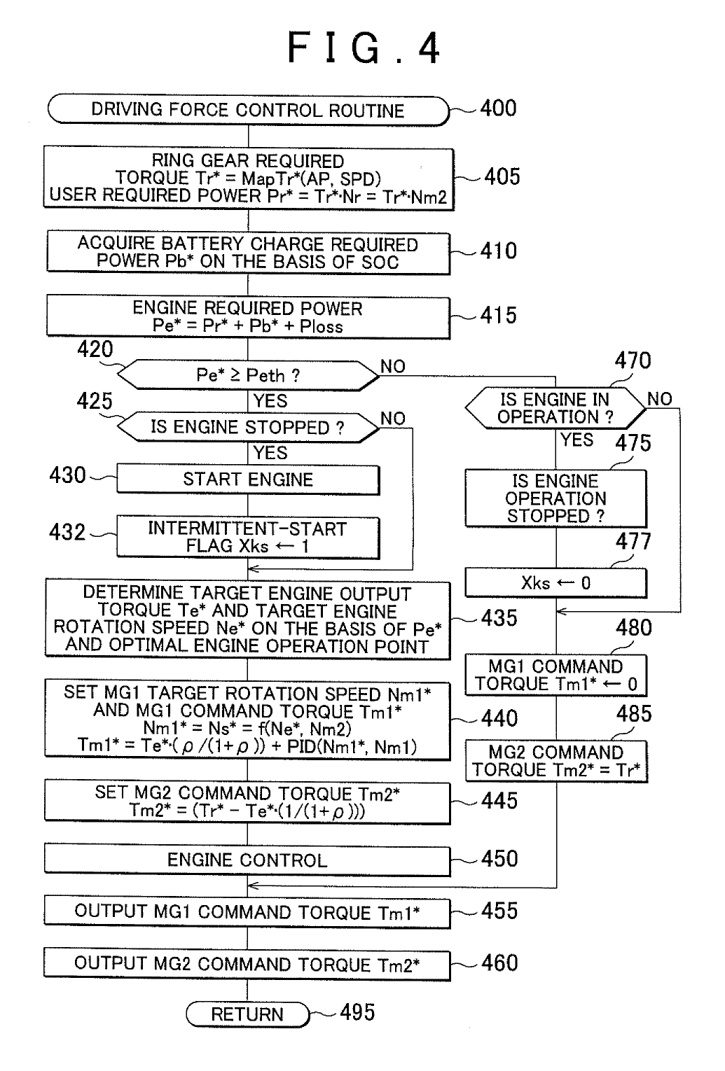

The PM executes a driving force control routine shown by the flowchart in FIG. 4 each time a predetermined period of time has elapsed. Thus, at predetermined timing, the PM starts the process from step 400 in FIG. 4, sequentially executes the processes of step 405 to step 415 (described below), and then proceeds with the process to step 420.

In step 405, the PM acquires a ring gear required torque Tr* by applying the accelerator operation amount AP and the vehicle speed SPD to a look-up table that defines the correlation among the accelerator operation amount AP, the vehicle speed SPD and the ring gear required torque Tr*. The ring gear required torque Tr* is directly proportional to a torque that is required to rotate the drive shaft 53 (user required torque Tu*). The PM acquires the product (Tr*·Nr) of the ring gear required torque Tr* and the rotation speed Nr of the ring gear 34 as a user required power Pr*. Note that the product (Tr*·Nr) is directly proportional to a vehicle required power that is the product (Tu*·SPD) of the user required torque Tu* and an actual vehicle speed SPD.

In step 410, the PM acquires a battery charge required power Pb* on the basis of the remaining level SOC. The battery charge required power Pb* is a value corresponding to an electric power that the battery 63 should be charged or the battery 63 should be discharged in order to keep the remaining level SOC around a predetermined remaining level center value SOCcent.

In step 415, the PM acquires a value (Pr*+Pb*+Ploss) obtained by adding a loss Ploss to the sum of the user required power Pr* and the battery charge required power Pb* as an engine required power Pe*. The engine required power Pe* is a power that is required for the engine 20.

Subsequently, the PM proceeds with the process to step 420, and determines whether the engine required power Pe* is higher than or equal to a threshold required power Peth. The threshold required power Peth is set to a value such that, when the engine 20 is operated at a power lower than the threshold required power Peth, the operation efficiency of the engine 20 (that is, fuel economy) becomes lower than or equal to a permissible limit. In other words, the threshold required power Peth is set to a value such that the efficiency of the engine 20 in the case where the engine 20 outputs a power equal to the threshold required power Peth at a maximum efficiency becomes lower than or equal to the permissible limit.

### Case 1

The engine required power Pe* is higher than or equal to the threshold required power Peth.

In this case, the PM makes affirmative determination in step 420 and proceeds with the process to step 425, and determines whether the engine 20 is stopped (the operation of the engine 20 is stopped) at the present time point. When the engine 20 is stopped, the PM makes affirmative determination in step 425 and proceeds with the process to step 430, and transmits an instruction signal (start instruction signal) for starting the operation of the engine 20 to the engine ECU 73. The engine ECU 73 starts the engine 20 on the basis of the instruction signal. Thus, the condition that the engine required power Pe* is higher than or equal to the threshold required power Peth is an engine start condition. After that, the PM sets the value of an intermittent start flag Xks to “1” in step 432, and then proceeds with the process to step 435. In contrast to this, when the engine 20 is in operation, the PM makes negative determination in step 425 and then directly proceeds with the process to step 435.

The PM sequentially executes the processes of step 435 to step 460 that will be described below. After that, the PM proceeds with the process to step 495, and once ends the routine.

In step 435, the PM determines a target engine output torque Te* and a target engine rotation speed Ne* on the basis of an optimal engine operation point corresponding to the engine required power Pe*. The optimal engine operation point is an operation point of the engine 20, which is determined by the output torque of the engine 20 and the engine rotation speed and which is obtained through an experiment, or the like, in advance such that the efficiency of the engine 20 is maximum in the case where the engine 20 outputs a certain power. That is, the PM determines the output torque of the engine 20 and the engine rotation speed Ne, at which the engine 20 is able to most efficiently output the engine required power Pe*, as the target engine output torque Te* and the target engine rotation speed Ne*, respectively.

In step 440, the PM substitutes the second MG rotation speed Nm2 equal to the rotation speed Nr into the following mathematical expression (1) as the rotation speed Nr of the ring gear 34, substitutes the target engine rotation speed Ne* into the following mathematical expression (1) as the engine rotation speed Ne, and then calculates an MG1 target rotation speed Nm1* equal to a target rotation speed Ns* of the sun gear 32.

Ns=Nm1=Nr−(Nr−Ne)·(1+ρ)/ρ

(Nm1*=Nm2−(Nm2−Ne*)·(1+ρ)/ρ) (1)

In the above mathematical expression (1), “ρ” is a value that is defined by the following mathematical expression (2). That is, “ρ” is the number of teeth of the sun gear 32 with respect to the number of teeth of the ring gear 34.

ρ=(the number of teeth of the sun gear 32/the number of teeth of the ring gear 34) (2)

In step 440, the PM calculates the MG1 command torque Tm1* that is a torque that should be output from the first motor generator MG1 in accordance with the following mathematical expression (3). In the mathematical expression (3), a value PID(Nm1*−Nm1) is a feedback amount that is used to bring the actual rotation speed Nm1 of the first motor generator MG1 into coincidence with the MG1 target rotation speed Nm1*.

Tm1=Te*·(ρ/(1+ρ))+PID(Nm1*−Nm1) (3)

The engine output torque Te* is converted by the planetary gear unit 31. As a result, a torque Tes expressed by the following mathematical expression (4) acts on the rotary shaft of the sun gear 32, and a torque Ter expressed by the following mathematical expression (5) acts on the rotary shaft of the ring gear 34. The mathematical expression (3) is a mathematical expression that is determined such that the balance between the torque Tes that is added from the engine 20 to the sun gear 32, indicated by the mathematical expression (4), and the output torque that is added from the first motor generator MG1 to the sun gear 32 is kept.

Tes=Te*·(ρ/(1+ρ)) (4)

Ter=Te*·(1/(1+ρ)) (5)

In step 445, the PM calculates the MG2 command torque Tm2* that is a torque that should be output from the second motor generator MG2 in accordance with the above-described mathematical expression (5) and the above-described mathematical expression (6). The mathematical expression (6) is a mathematical expression that is determined such that the balance among the torque Ter that is added from the engine 20 to the ring gear 34, indicated by the mathematical expression (5), the output torque Tm2* that is added from the second motor generator MG2 to the ring gear 34 and the ring gear required torque Tr* is kept. Note that the PM may determine the MG2 command torque Tm2* on the basis of the following mathematical expression (7).

Tm2*=Tr*−Ter (6)

Tm2*=Tr*−Tm1*/ρ (7)

In step 450, the PM transmits a command signal to the engine ECU 73 such that the engine 20 is operated at the optimal engine operation point (in other words, the engine output torque becomes the target engine output torque Te*). By so doing, the engine ECU 73 controls the engine 20 such that the engine output torque Te becomes the target engine output torque Te*.

In step 455, the PM transmits the MG1 command torque Tm1* to the motor ECU 72. The motor ECU 72 controls the first inverter 61 such that the output torque of the first motor generator MG1 coincides with the MG1 command torque Tm1*.

As a result, the rotation speed Nm1 of the first motor generator MG1 coincides with the MG1 target rotation speed Nm1*, so the engine rotation speed Ne coincides with the target engine rotation speed Ne*. In step 460, the PM transmits the MG2 command torque Tm2* to the motor ECU 72. The motor ECU 72 controls the second inverter 62 such that the output torque of the second motor generator MG2 coincides with the MG2 command torque Tm2*.

Through the above processes, the torque equal to the ring gear required torque Tr* is caused to act on the ring gear 34 by the engine 20 and the second motor generator MG2.

### Case 2

The engine required power Pe* is lower than the threshold required power Peth.

In Case 2, when the PM proceeds with the process to step 420, the PM makes negative determination in step 420 and then proceeds with the process to step 470, and determines whether the engine 20 is in operation at the present time point.

When the engine 20 is in operation, the PM makes affirmative determination in step 470 and proceeds with the process to step 475, and transmits an instruction signal for stopping the operation of the engine 20 to the engine ECU 73. The engine ECU 73 carries out fuel cut on the basis of the instruction signal (that is, sets the fuel injection amount to “0”), and stops the operation of the engine 20. After that, the PM proceeds with the process to step 477, sets the value of the intermittent start flag Xks to “0”, and proceeds with the process to step 480. In contrast to this, when the engine 20 is stopped, the PM makes negative determination in step 470, and directly proceeds with the process to step 480. In this way, the value of the intermittent start flag Xks is set to “1” when the engine 20 is started through intermittent operation (see step 432), and is set to “0” when the operation of the engine 20 is stopped through intermittent operation (see step 477).

Subsequently, the PM proceeds with the process to step 480 and sets the MG1 command torque Tm1* to “0”, and then proceeds with the process to step 485 and sets the ring gear required torque Tr* for the MG2 command torque TM2*. After that, the PM executes the above-described processes of step 455 to step 460. As a result, the ring gear required torque Tr* (thus, the user required torque Tu) is fulfilled only by the torque that is generated by the second motor generator MG2.

### Operation: Setting of Target Air-fuel Ratio

The EG executes a target air-fuel ratio determination routine shown by the flowchart in FIG. 5 each time a predetermined period of time has elapsed. Thus, at appropriate timing, the EG starts processing from step 500 of FIG. 5 and then proceeds with the process to step 510, and then determine the target air-fuel ratio abyfr by subtracting the sum of a sub-feedback amount KSFB and a catalyst state correction amount Kcat from the stoichiometric air-fuel ratio stoich (for example, 14.6). That is, the EG corrects the target air-fuel ratio on the basis of the sub-feedback amount KSFB and the catalyst state correction amount Kcat.

The sub-feedback amount KSFB is also referred to as “target air-fuel ratio correction amount”, and is separately calculated on the basis of the output value Voxs of the downstream air-fuel ratio sensor 96 as will be described later. The catalyst state correction amount Kcat is a correction amount by which the target air-fuel ratio abyfr is corrected such that the air-fuel ratio of exhaust gas flowing into the catalyst 29 coincides with an air-fuel ratio (that is, a catalyst required air-fuel ratio) that is required for the catalyst 29 to efficiently purify exhaust gas. The catalyst state correction amount Kcat is separately calculated as will be described later. The target air-fuel ratio abyfr is stored in the RAM in correspondence with each intake stroke.

### Operation: Fuel Injection Control

The EG repeatedly executes fuel injection control routine shown in FIG. 6 over any one of the cylinders each time the crank angle of the any one of the cylinders coincides with a predetermined crank angle before the intake top dead center. The predetermined crank angle is, for example, BTDC90° CA (90° CA before the intake top dead center). The cylinder of which the crank angle coincides with the predetermined crank angle is also referred to as “fuel injection cylinder”. The EG calculates the instructed fuel injection amount Fi and issues instructions for fuel injection through the fuel injection control routine.

When the crank angle of any one of the cylinders coincides with the predetermined crank angle before the intake top dead center, the EG starts processing from step 600, and determines in step 610 whether a fuel cut condition (hereinafter, referred to as “FC condition”) is satisfied. The FC condition is also satisfied when the value of the intermittent start flag Xks is changed from “1” to “0” (in other words, when the engine operation stop condition is satisfied).

Now, it is assumed that the FC condition is not satisfied. In this case, the EG makes negative determination in step 610, and sequentially executes the processes of step 620 to step 660 that will be described below, after which the EG proceeds with the process to step 695 and once ends the routine.

In step 620, the EG loads the target air-fuel ratio abyfr that is determined by the above-described routine shown in FIG. 5. In step 630, the EG acquires the in-cylinder intake air flow rate Mc(k) on the basis of the actual intake air flow rate Ga, the actual engine rotation speed Ne and the look-up table MapMc(Ga, Ne). The in-cylinder intake air flow rate Mc(k) is the amount of air that is taken into the fuel injection cylinder through the single intake stroke of the fuel injection cylinder. The in-cylinder intake air flow rate Mc(k) is stored in the RAM in correspondence with each intake stroke.

In step 640, the EG obtains a basic fuel injection amount Fbase by dividing the in-cylinder intake air flow rate Mc(k) by the target air-fuel ratio abyfr. Thus, the basic fuel injection amount Fbase is a feedforward amount of the fuel injection amount, which is required for calculation in order to obtain the target air-fuel ratio abyfr. Step 640 constitutes a feedforward control unit (air-fuel ratio control unit) that is used to bring the air-fuel ratio of air-fuel mixture that is supplied to the engine into coincidence with the target air-fuel ratio abyfr.

In step 650, the EG corrects the basic fuel injection amount Fbase using a main feedback amount DFi. More specifically, the EG calculates the instructed fuel injection amount (final fuel injection amount) Fi by adding the main feedback amount DFi to the basic fuel injection amount Fbase. The main feedback amount DFi is an air-fuel ratio feedback amount that is used to bring the air-fuel ratio of exhaust gas flowing into the catalyst 29 (upstream air-fuel ratio abyfs) into coincidence with the target air-fuel ratio abyfr. A method of calculating the main feedback amount DFi will be described later.

In step 660, the EG transmits an injection instruction signal for causing fuel of the instructed fuel injection amount Fi to be injected from the fuel injection valve 24 provided in correspondence with the fuel injection cylinder, to the fuel injection valve 24.

When the FC condition is satisfied at the time point at which the EG executes the process of step 610, the EG makes affirmative determination in step 610, directly proceeds with the process to step 695, and once ends the routine. In this case, fuel injection through the process of step 660 is not carried out, so fuel cut control (fuel supply stop control) is executed.

### Operation: Calculation of Main Feedback Amount

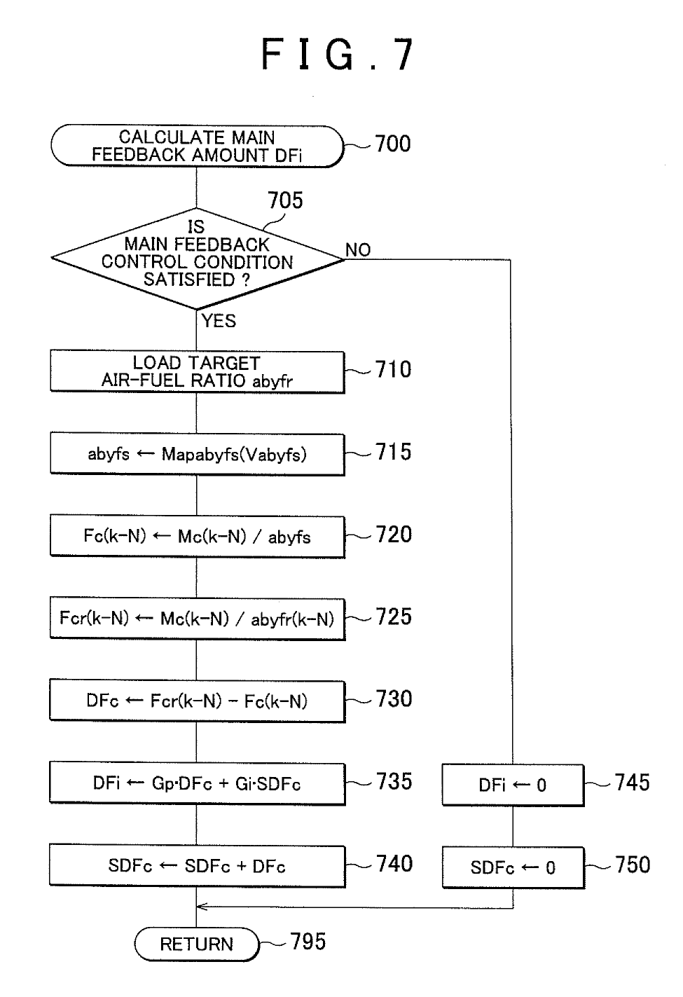

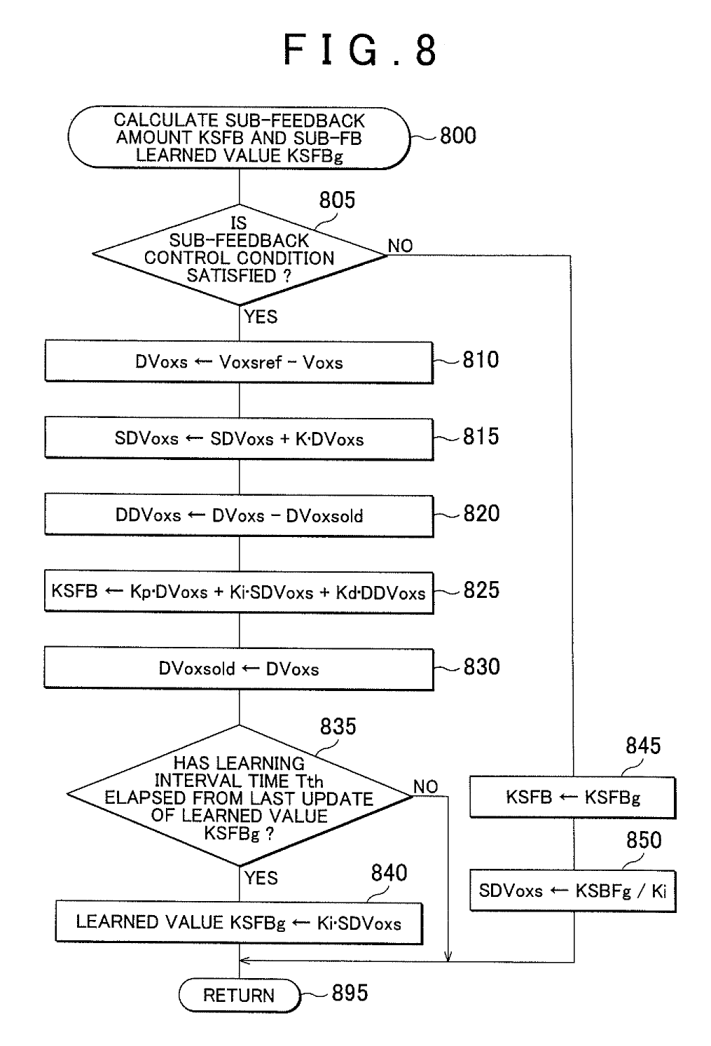

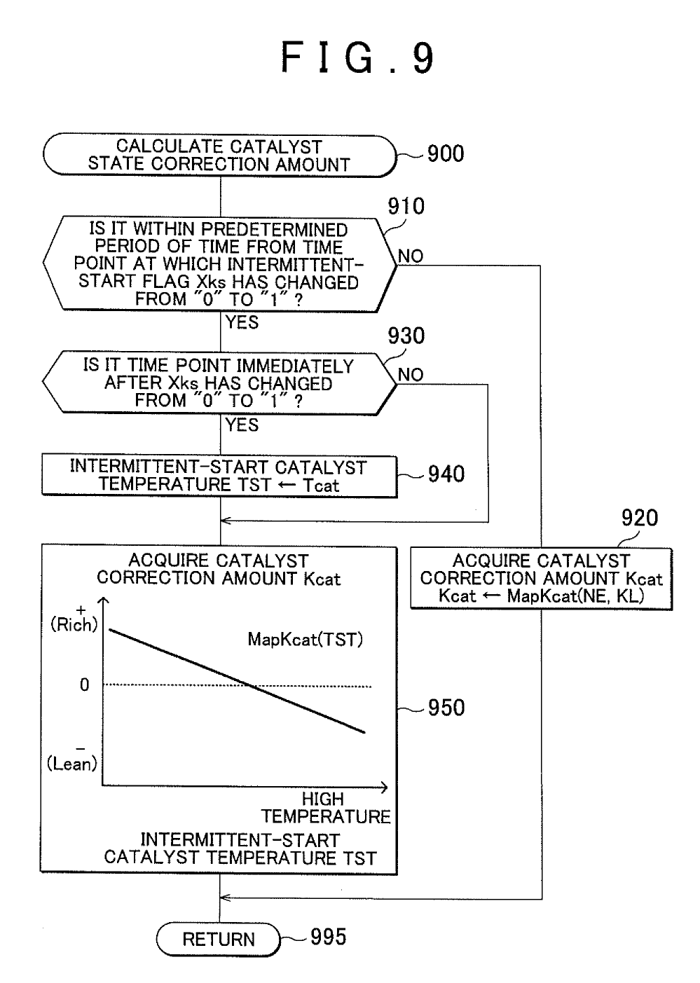

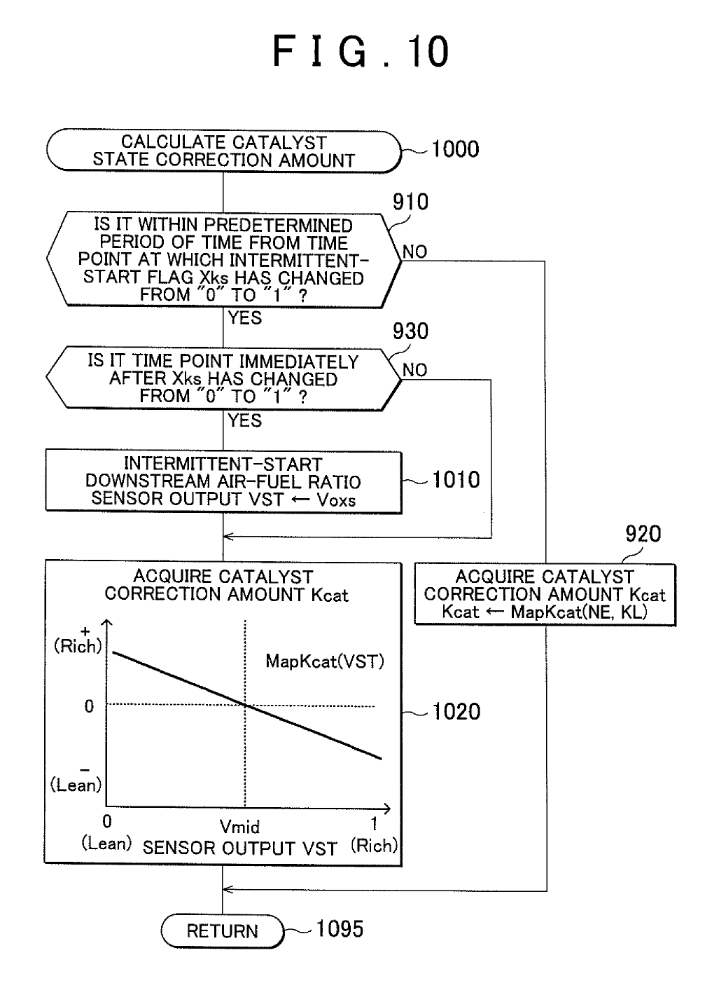

The EG repeatedly executes a main feedback amount calculation routine shown by the flowchart in FIG. 7 each time a predetermined period of time has elapsed. Thus, at predetermined timing, the EG starts processing from step 700, proceeds with the process to step 705, and determines whether the main feedback control condition (upstream air-fuel ratio feedback control condition) is satisfied.

The main feedback control condition is satisfied when all the following conditions are satisfied.

(A1) The upstream air-fuel ratio sensor 95 is activated.
(A2) A load KL of the engine is smaller than or equal to a threshold KLth.
(A3) Fuel cut is not being carried out (the engine 20 is not stopped).

The load KL is a load factor that is obtained by the following mathematical expression (8). The accelerator operation amount AP may be used instead of the load KL. In the mathematical expression (8), Mc is an in-cylinder intake air flow rate, pair is an air density (unit: g/l), L is a displacement of the engine 20 (unit: 1), and “4” is the number of cylinders of the engine 20.

KL=(Mc/(ρair·L/4))·100% (8)

Now, the description will be continued on the assumption that the main feedback control condition is satisfied. In this case, the EG makes affirmative determination in step 705, and sequentially executes the processes of step 710 to step 740 that will be described below, after which the EG proceeds with the process to step 795 and once ends the routine.

In step 710, the EG loads the target air-fuel ratio abyfr that is separately calculated by the routine shown in FIG. 5. In step 715, the EG obtains the upstream air-fuel ratio abyfs by applying the output value Vabyfs of the upstream air-fuel ratio sensor 95 to the table Mapabyfs shown in FIG. 2. In step 720, the EG obtains an in-cylinder fuel supply amount Fc(k−N) that is the amount of fuel actually supplied to the combustion chamber at the time point N cycles before the present time point. That is, the EG obtains the in-cylinder fuel supply amount Fc(k−N) by dividing the in-cylinder intake air flow rate Mc(k−N) at the time point N cycles (that is, N·720° crank angle) before the present time point by the upstream air-fuel ratio abyfs.

In step 725, the EG obtains a target in-cylinder fuel supply amount Fcr(k−N) that is the amount of fuel that should be supplied to the combustion chamber at the time point N cycles before the present time point. That is, the EG obtains the target in-cylinder fuel supply amount Fcr(k−N) by dividing the in-cylinder intake air flow rate Mc(k−N) N cycles before the present time point by the target air-fuel ratio abyfr(k−N) N cycles before the present time point.

In step 730, the EG obtains an in-cylinder fuel supply amount deviation DFc by subtracting the in-cylinder fuel supply amount Fc(k−N) from the target in-cylinder fuel supply amount Fcr(k−N). The in-cylinder fuel supply amount deviation DFc is an amount that indicates an excess or deficiency of fuel supplied into the cylinder at the time point N cycles before. In step 735, the EG obtains the main feedback amount DFi by the mathematical expression described in a block 735. In this mathematical expression, Gp is a preset proportional gain, and G1 is a preset integral gain. Furthermore, a value SDFc is an integral value of the in-cylinder fuel supply amount deviation DFc. That is, the EG calculates the main feedback amount DFi through proportional-plus-integral control for bringing the upstream air-fuel ratio abyfs into coincidence with the target air-fuel ratio abyfr.

In step 740, the EG acquires a new integral value SDFc of the in-cylinder fuel supply amount deviation by adding the in-cylinder fuel supply amount deviation DFc obtained in step 730 to the integral value SDFc of the in-cylinder fuel supply amount deviation DFc at that time point.

Thus, the main feedback amount DFi is calculated, and the main feedback amount DFi is incorporated into the instructed fuel injection amount Fi through the above-described process of step 650 of FIG. 6. Thus, the main feedback amount DFi is a feedback amount of the fuel injection amount for bringing the upstream air-fuel ratio abyfs that is indicated by the output value Vabyfs of the upstream air-fuel ratio sensor 95 into coincidence with the target air-fuel ratio abyfr.

On the other hand, at the time of determination in step 705 of FIG. 7, when the main feedback control condition is not satisfied, the EG makes negative determination in step 705, proceeds with the process to step 745, and sets the value of the main feedback amount DFi to “0”. Subsequently, the EG stores “0” in the integral value SDFc of the in-cylinder fuel supply amount deviation in step 750. After that, the EG proceeds with the process to step 795 and once ends the routine.

### Operation: Calculation of Sub-Feedback Amount and Sub-Feedback Learned Value

The EG repeatedly executes a routine for calculating a sub-feedback amount KSFB and a sub-feedback learned value KSFBg, shown by the flowchart in FIG. 8, each time a predetermined period of time has elapsed. The sub-feedback learned value KSFBg is referred to as sub-FB learned value KSFBg.

At appropriate timing, the EG starts processing from step 800, proceeds with the process to step 805, and determines whether a sub-feedback control condition is satisfied.

The sub-feedback control condition is satisfied when all the following conditions are satisfied.

(B1) The main feedback control condition is satisfied.
(B2) The downstream air-fuel ratio sensor 96 is activated.

Now, the description will be continued on the assumption that the sub-feedback control condition is satisfied. In this case, the EG makes affirmative determination in step 805, and executes the processes (sub-feedback amount calculation process) of step 810 to step 830 that will be described below, after which the EG proceeds with the process to step 835.

In step 810, the EG acquires an output deviation amount DVoxs that is a difference between a downstream target value Voxsref and the output value Voxs of the downstream air-fuel ratio sensor 96. The downstream target value Voxsref is set to a value corresponding to a reference air-fuel ratio abyfr0 within the window of the three-way catalyst 29 (in this case, the middle voltage Vmid corresponding to the stoichiometric air-fuel ratio stoich). Immediately after the sub-feedback control condition is satisfied, the output deviation amount DVoxs is set to “0”.

In step 815, the EG obtains a new integral value SDVoxs of the output deviation amount by adding the product of the output deviation amount DVoxs obtained in step 810 and a gain K to the integral value SDVoxs of the output deviation amount at that time point. The gain K is set at “1” here. Immediately after the sub-feedback control condition is satisfied, the integral value SDVoxs is set to a value that is obtained by dividing the sub-FB learned value KSFBg by an integral gain Ki.

In step 820, the EG obtains a new derivative value DDVoxs of the output deviation amount by subtracting a previous output deviation amount DVoxsold, which is the output deviation amount calculated at the time when the routine has been executed last time, from the output deviation amount DVoxs calculated in step 810. Immediately after the sub-feedback control condition is satisfied, the derivative value DDVoxs is set to “0”.

In step 825, the EG obtains the sub-feedback amount KSFB by the mathematical expression described in a block 825. In this mathematical expression, Kp is a preset proportional gain (proportionality constant), Ki is a preset integral gain (integration constant), and Kd is a preset derivative gain (derivative constant). That is, Kp·DVoxs is a proportional term, Ki·SDVoxs is an integral term and Kd·DDVoxs is a derivative term. The integral term Ki·SDVoxs is a steady component of the sub-feedback amount KSFB.

In step 830, the EG stores the output deviation amount DVoxs calculated in step 810 as the previous output deviation amount DVoxsold.

In this way, the EG calculates the sub-feedback amount KSFB through proportional-plus-integral-plus-derivative (PID) control for bringing the output value Voxs of the downstream air-fuel ratio sensor 96 into coincidence with the downstream target value Voxsref.

That is, when the output value Voxs is smaller (leaner) than the downstream target value Voxsref, the sub-feedback amount KSFB gradually increases. As the sub-feedback amount KSFB increases, the target air-fuel ratio abyfr is corrected so as to reduce (become richer) (see step 510 of FIG. 5). As a result, the air-fuel ratio of the engine 20 reduces (becomes richer), so the output value Voxs is increased so as to coincide with the downstream target value Voxsref.

Conversely, when the output value Voxs is larger (richer) than the downstream target value Voxsref, the sub-feedback amount KSFB gradually reduces. As the sub-feedback amount KSFB reduces, the target air-fuel ratio abyfr is corrected to increase (become leaner) (see step 510 of FIG. 5). As a result, the air-fuel ratio of the engine 20 increases (becomes leaner), so the output value Voxs reduces so as to coincide with the downstream target value Voxsref.

When the EG proceeds with the process to step 835, the EG determines whether a sub-feedback amount learning condition is satisfied. Here, the sub-feedback amount learning condition is satisfied when a learning interval time Tth has elapsed from the time point at which the sub-FB learned value KSFBg is updated last time. At this time, when the learning interval time Tth has not elapsed from the time point at which the sub-FB learned value KSFBg is updated last time, the EG makes negative determination in step 835, directly proceeds with the process to step 895, and once ends the routine.

In contrast to this, at the time point at which the EG executes the process of step 835, when the learning interval time Tth has elapsed from the time point at which the sub-FB learned value KSFBg is updated last time, the EG makes affirmative determination in step 835, proceeds with the process to step 840, and stores the product (Ki·SDVoxs) of the integral value SDVoxs and the integral gain Ki at that time point in the backup RAM as the sub-FB learned value KSFBg. After that, the EG proceeds with the process to step 895 and once ends the routine. The learning interval time Tth that is used in determination of step 835 is accumulated as long as the engine 20 is in operation. In other words, even immediately after the engine 20 is started through intermittent operation, the sub-feedback amount KSFB is learned.

On the other hand, when the sub-feedback control condition is not satisfied at the time point at which the EG executes the process of step 805, the EG makes negative determination in step 805, proceeds with the process to step 845, and sets the sub-FB learned value KSFBg as the sub-feedback amount KSFB. Subsequently, the EG proceeds with the process to step 850, and stores a value, obtained by dividing the sub-FB learned value KSFBg by the integral gain Ki, in the backup RAM as the integral value SDVoxs. After that, the EG proceeds with the process to step 895, and once ends the routine.

Through the above processes, when the sub-feedback control condition is not satisfied (that is, when the sub-feedback amount KSFB cannot be updated on the basis of the output value Voxs of the downstream air-fuel ratio sensor 96), the target air-fuel ratio abyfr is corrected by the sub-FB learned value KSFBg (see step 845 of FIG. 8 and step 510 of FIG. 5). Furthermore, when the sub-feedback control condition changes from a non-satisfied state to a satisfied state, the sub-feedback amount KSFB starts changing from the sub-FB learned value KSFBg.

### Operation: Calculation of Catalyst State Correction Amount

The EG repeatedly executes a catalyst state correction amount calculation routine shown by the flowchart in FIG. 9 each time a predetermined period of time has elapsed. Thus, at appropriate timing, the EG starts processing from step 900, proceeds with the process to step 910, and determines whether the present time point falls within a predetermined period of time after the time point at which the value of the intermittent start flag Xks has changed from “0” to “1”. That is, the EG determines whether it is within the predetermined period of time from a start of the engine 20 through intermittent operation to when the predetermined period of time elapses. The predetermined period of time may be a set period of time or may be a variable period of time, such as a period of time by which the integral value of the intake air flow rate Ga (or the instructed fuel injection amount Fi) from a start of the engine 20 through intermittent operation reaches a predetermined value.

At this time, when the condition of step 910 is not satisfied, the EG makes negative determination in step 910, proceeds with the process to step 920, and acquires the catalyst state correction amount Kcat during engine normal operation by applying the intake air flow rate Ga and the engine rotation speed Ne at that time point to the look-up table MapKcat(Ga, Ne). After that, the EG proceeds with the process to step 995, and once ends the routine.

In contrast to this, when the present time point falls within the predetermined period of time from the time point at which the value of the intermittent start flag Xks has changed from “0” to “1”, the EG makes affirmative determination in step 910, proceeds with the process to step 930, and determines whether the current time point is time point immediately after the value of the intermittent start flag Xks has changed from “0” to “1”. That is, the EG determines whether the present time point is time point immediately after a start of the engine 20 through intermittent operation.

When the present time point is time point immediately after the value of the intermittent start flag Xks has changed from “0” to “1”, the EG makes affirmative determination in step 930, proceeds with the process to step 940, and acquires a catalyst temperature Teat at that time point as an intermittent-start catalyst temperature TST. The intermittent-start catalyst temperature TST is a parameter (catalyst parameter) that shows a state of the catalyst 29 at the time point immediately after a start of the engine 20 through intermittent operation. After that, the EG proceeds with the process to step 950. When the present time point is not time point immediately after the value of the intermittent start flag Xks has changed from “0” to “1”, the EG makes negative determination in step 930, and directly proceeds with the process to step 950.

The EG estimates an exhaust gas temperature Tex by applying the load KL and the engine rotation speed Ne to a look-up table each time a predetermined period of time has elapsed during a period in which the engine 20 is in operation. Furthermore, the EG estimates the catalyst temperature Tcat in accordance with the following mathematical expression (9) during a period in which the engine 20 is in operation. α is a constant that is larger than 0 and smaller than 1, and Tcatold is a catalyst temperature Teat estimated a predetermined period of time before.

Tcat=(1−αTcatold+α·Tex (9)

In addition, the EG estimates the catalyst temperature Teat in accordance with the mathematical expression (10) each time a predetermined period of time has elapsed during a period in which the operation of the engine 20 is stopped. ΔT may be a constant value or may be a value that increases as an outside air temperature decreases. Furthermore, ΔT may be a value that increases as the vehicle speed SPD increases.

Tcat=Tcatold−ΔT (10)

When a catalyst temperature sensor that measures the temperature of the catalyst 29 is arranged, the catalyst temperature Teat may be acquired on the basis of an output value of the catalyst temperature sensor.

In step 950, the EG acquires the catalyst state correction amount Kcat by applying the intermittent-start catalyst temperature TST acquired in step 940 to a look-up table MapKcat(TST) shown in a block 950. After that, the EG proceeds with the process to step 995, and once ends the routine.

In the present embodiment, the catalyst 29 is configured such that, as the catalyst temperature Teat increases, an oxygen release reaction is faster than an oxygen storage reaction. That is, the catalyst 29 has a characteristic that oxygen becomes insufficient (characteristic that an oxygen storage amount reduces) as the catalyst temperature Teat increases. Thus, the table MapKcat(TST) is set such that, as the intermittent-start catalyst temperature TST increases, the target air-fuel ratio abyfr is corrected to become leaner (larger). That is, according to the table MapKcat(TST), the catalyst state correction amount Kcat is determined such that the catalyst state correction amount Kcat is a negative value and the absolute value of the catalyst state correction amount Kcat increases as the intermittent-start catalyst temperature TST increases, and is determined such that the catalyst state correction amount Kcat is a positive value and the absolute value of the catalyst state correction amount Kcat increases as the intermittent-start catalyst temperature TST decreases (see step 510 of FIG. 5).

When the catalyst 29 is configured such that, as the catalyst temperature Tcat increases, the oxygen storage reaction is faster than the oxygen release reaction, the catalyst 29 has a characteristic that oxygen becomes excessive (characteristic that the oxygen storage amount increases) as the catalyst temperature Tcat increases. Thus, the table MapKcat(TST) in this case is set such that, as the intermittent-start catalyst temperature TST increases, the target air-fuel ratio abyfr is corrected to be richer (smaller). That is, according to the table MapKcat(TST) in this case, the catalyst state correction amount Kcat is determined such that the catalyst state correction amount Kcat is a positive value and the absolute value of the catalyst state correction amount Kcat increases as the intermittent-start catalyst temperature TST increases, and is determined such that the catalyst state correction amount Kcat is a negative value and the absolute value of the catalyst state correction amount Kcat increases as the intermittent-start catalyst temperature TST decreases.

In this way, the catalyst state correction amount Kcat is determined, so the target air-fuel ratio abyfr is corrected on the basis of the intermittent-start catalyst temperature TST that is one of catalyst parameters that indicate the state of the catalyst 29, acquired at the time of a start of the engine 20 through intermittent operation, in a predetermined period after a start of the engine 20 through intermittent operation. After that, after a start of the engine 20 through intermittent operation, the air-fuel ratio of exhaust gas flowing into the catalyst 29 becomes a value close to the catalyst required air-fuel ratio. That is, the downstream air-fuel ratio afdown does not significantly deviate from the air-fuel ratio (that is, the stoichiometric air-fuel ratio stoich) corresponding to the downstream target value Voxsref (=middle voltage Vmid), so the sub-feedback amount KSFB does not significantly change. Thus, the learned value KSFBg of the sub-feedback amount KSFB is a learned value close to the sub-feedback amount in the case where the catalyst 29 does not receive the influence of intermittent operation (that is, the case where the engine 20 is in steady operation). That is, learning based on the output value Voxs of the downstream air-fuel ratio sensor 96 is properly carried out.

### Second Embodiment

Next, an air-fuel ratio control apparatus (hereinafter, simply referred to as “second device”) according to a second embodiment of the invention will be described. The second device differs from the first device only in the method of calculating the catalyst state correction amount Kcat. Thus, hereinafter, description will be made focusing on the difference.

The EG of the second device repeatedly executes a catalyst state correction amount calculation routine shown in FIG. 10 instead of FIG. 9 each time a predetermined period of time has elapsed. The routine shown in FIG. 10 differs from the routine shown in FIG. 9 only in that step 940 and step 950 in FIG. 9 are respectively replaced with step 1010 and step 1020.

Thus, when the present time point is time point immediately after the value of the intermittent start flag Xks has changed from “0” to “1” (when the present time point is time point immediately after a start of the engine 20 through intermittent operation), the EG of the second device proceeds with the process from step 930 to step 1010, and acquires the output value Voxs of the downstream air-fuel ratio sensor 96 at that time point as an intermittent-start output value VST. The intermittent-start output value VST is a parameter (catalyst parameter) that indicates the state of the catalyst 29 at the time point immediately after a start of the engine 20 through intermittent operation. After that, the EG proceeds with the process to step 1020. When the present time point is not time point immediately after the value of the intermittent start flag Xks has changed from “0” to “1”, the EG makes negative determination in step 930, and directly proceeds with the process to step 1020.

In step 1020, the EG acquires the catalyst state correction amount Kcat by applying the intermittent-start output value VST acquired in step 1010 to a look-up table MapKcat(VST) shown in a block 1020. After that, the EG proceeds with the process to step 1095 and once ends the routine.

As the intermittent-start output value VST increases within a range higher than or equal to the middle voltage Vmid corresponding to the stoichiometric air-fuel ratio stoich (in other words, as the downstream air-fuel ratio afdown indicated by the intermittent-start output value VST becomes richer), the oxygen storage amount of the catalyst 29 is more insufficient, so the table MapKcat(VST) is set such that the target air-fuel ratio abyfr is corrected to be leaner (larger). That is, according to the table MapKcat(VST), the catalyst state correction amount Kcat is determined such that the catalyst state correction amount Kcat becomes a negative value and the absolute value of the catalyst state correction amount Kcat increases as the intermittent-start output value VST increases within the range higher than or equal to the middle voltage Vmid (see step 510 of FIG. 5).

In contrast to this, as the intermittent-start output value VST decreases within a range lower than or equal to the middle voltage Vmid corresponding to the stoichiometric air-fuel ratio stoich (in other words, as the downstream air-fuel ratio afdown indicated by the intermittent-start output value VST becomes leaner), the oxygen storage amount of the catalyst 29 is more excessive, so the table MapKcat(VST) is set such that the target air-fuel ratio abyfr is corrected to be richer (smaller). That is, according to the table MapKcat(VST), the catalyst state correction amount Kcat is determined such that the catalyst state correction amount Kcat is a positive value and the absolute value of the catalyst state correction amount Kcat increases as the intermittent-start output value VST reduces within the range lower than or equal to the middle voltage Vmid (see step 510 of FIG. 5).

In this way, the catalyst state correction amount Kcat is determined, so the target air-fuel ratio abyfr is corrected on the basis of the intermittent-start output value VST that is one of catalyst parameters that indicate the state of the catalyst 29, acquired at the time of a start of the engine 20 through intermittent operation, in a predetermined period after a start of the engine 20 through intermittent operation. After that, after a start of the engine 20 through intermittent operation, the air-fuel ratio of exhaust gas flowing into the catalyst 29 becomes a value close to the catalyst required air-fuel ratio. That is, the downstream air-fuel ratio afdown does not significantly deviate from the air-fuel ratio (that is, the stoichiometric air-fuel ratio stoich) corresponding to the downstream target value Voxsref, so the sub-feedback amount KSFB does not significantly change. Thus, the learned value KSFBg of the sub-feedback amount KSFB is a learned value close to the sub-feedback amount in the case where the catalyst 29 does not receive the influence of intermittent operation (that is, the case where the engine 20 is in steady operation). That is, learning based on the output value Voxs of the downstream air-fuel ratio sensor 96 is properly carried out.

As described above, the first and second devices are applied to the engine 20 that is mounted on the hybrid vehicle 10 that serves as a driving source together with the electric motor (second motor generator MG2), that includes the catalyst 29 in the exhaust passage and that intermittently repeats a stop and start of its operation on the basis of the operating state of the hybrid vehicle 10 (see step 420 to step 430, step 470 and step 475 in FIG. 4).

Furthermore, the first and second devices include: the feedback control unit (see the routines of FIG. 5 to FIG. 8) and an air-fuel ratio changing unit (see affirmative determination in step 910, and step 950 in FIG. 9, affirmative determination in step 910, and step 1020 in FIG. 10 and step 510 in FIG. 5). The feedback control unit executes air-fuel ratio feedback control for controlling the air-fuel ratio of the engine such that the air-fuel ratio of air-fuel mixture that is supplied to the engine 20 (the air-fuel ratio of the engine) coincides with the target air-fuel ratio abyfr on the basis of the output (output value Vabyfs) of the upstream air-fuel ratio sensor 95 and the output (output value Voxs) of the downstream air-fuel ratio sensor 96. The air-fuel ratio changing unit acquires the catalyst parameter (the intermittent-start catalyst temperature TST or the intermittent-start output value VST) that indicates the state of the catalyst 29 at the time point at which the engine 20 is started after the operation of the engine 20 is stopped in response to the operating state of the hybrid vehicle 10 (see step 930 and step 940 in FIG. 9 and step 930 and step 1010 in FIG. 10), and changes the air-fuel ratio of exhaust gas flowing into the catalyst 29 by changing the target air-fuel ratio abyfr on the basis of the acquired catalyst parameter in the predetermined period after the time point at which the engine 20 is started.

Thus, according to the first and second devices, when the operation of the engine 20 is stopped through intermittent operation and, after that, the engine 20 is started, the state of the catalyst 29 (for example, catalyst temperature and/or oxygen storage amount, or the like) at the time of a start of the engine 20 is incorporated into air-fuel ratio control in the predetermined period thereafter. Thus, when the operation of the engine 20 is stopped through intermittent operation and, after that, the engine 20 is started, after this time point, it is possible to bring the air-fuel ratio of exhaust gas flowing into the catalyst 29 close to the catalyst required air-fuel ratio. As a result, it is possible to improve emissions.

Furthermore, in the first and second devices, the feedback control unit is configured to execute the air-fuel ratio feedback control (see step 510 of FIG. 5 and the routines of FIG. 6 and FIG. 7) by calculating the target air-fuel ratio correction amount (sub-feedback amount KSFB) on the basis of the output (output value Voxs) of the downstream air-fuel ratio sensor 96 such that the output (output value Voxs) of the downstream air-fuel ratio sensor 96 coincides with the downstream target value Voxsref (see step 805 to step 830 in FIG. 8), correcting the target air-fuel ratio abyfr on the basis of the target air-fuel ratio correction amount (sub-feedback amount KSFB) (step 510 of FIG. 5), and controlling the air-fuel ratio of the engine such that the upstream air-fuel ratio abyfs indicated by the output (output value Vabyfs) of the upstream air-fuel ratio sensor 95 coincides with the corrected target air-fuel ratio (stoich-KSFB), and to acquire a learned value (sub-FB learned value KSFBg) by learning the target air-fuel ratio correction amount (sub-feedback amount KSFB) and use a value (sub-FB learned value KSFBg) based on the learned value as the target air-fuel ratio correction amount for correcting the target air-fuel ratio abyfr at least in a period during which the condition that the target air-fuel ratio correction amount (sub-feedback amount KSFB) cannot be updated on the basis of the output (output value Voxs) of the downstream air-fuel ratio sensor 96 is satisfied (see negative determination in step 805, and step 845 in FIG. 8 and step 510 in FIG. 5), and the air-fuel ratio changing unit is configured to correct the target air-fuel ratio abyfr on the basis of the acquired catalyst parameter (the intermittent-start catalyst temperature TST or the intermittent-start output value VST) (see step 510 in FIG. 5, step 940 and step 950 in FIG. 9 and step 1010 and step 1020 in FIG. 10).

Thus, the target air-fuel ratio abyfr is corrected on the basis of the catalyst parameter immediately after a start of the engine 20 through intermittent operation, so it is less likely that the target air-fuel ratio correction amount (sub-feedback amount KSFB) significantly deviates from the target air-fuel ratio correction amount in the case where the state of the catalyst 29 is stable. Thus, it is possible to start learning the target air-fuel ratio correction amount (sub-feedback amount KSFB) from the time point at which the engine 20 is started through intermittent operation, so the opportunity of learning does not reduce, and it is possible to early acquire an appropriate learned value (sub-FB learned value KSFBg).

### Alternative Embodiment

Next, an alternative embodiment to the first device and the second device will be described. In the first device and the second device, the sub-feedback amount KSFB and the catalyst state correction amount Kcat are values by which the target air-fuel ratio abyfr is directly corrected as shown in step 510 of FIG. 5. In contrast to this, in the alternative embodiment, the sub-feedback amount KSFB and the catalyst state correction amount Kcat are values by which the output value Vabyfs of the upstream air-fuel ratio sensor 95 is corrected.

More specifically, the EG acquires a control output value Vabyfc by correcting the output value Vabyfs using the sub-feedback amount KSFB and the catalyst state correction amount Kcat as shown in the following mathematical expression (11). Note that the target air-fuel ratio abyfr is kept at the stoichiometric air-fuel ratio stoich.

Vabyfc=Vabyfs+KSFB+Kcat (11)

The EG acquires an upstream control air-fuel ratio abyfc by applying the control output value Vabyfc to the table Mapabyfs shown in FIG. 2 (abyfc=Mapabyfs(Vabyfc)). In step 720 of FIG. 7, the EG uses the upstream control air-fuel ratio abyfc instead of the upstream air-fuel ratio abyfs.

That is, in this alternative embodiment, the main feedback amount DFi is calculated such that the upstream control air-fuel ratio abyfc coincides with the target air-fuel ratio abyfr that is kept at the stoichiometric air-fuel ratio stoich, and the basic fuel injection amount Fbase is corrected using the main feedback amount DFi.

The upstream control air-fuel ratio abyfc may be calculated by correcting the upstream air-fuel ratio abyfs, which is obtained by applying the output value Vabyfs to the table Mapabyfs shown in FIG. 2, on the basis of the sub-feedback amount KSFB and the catalyst state correction amount Kcat as shown in the following mathematical expression (12).

abyfc=abyfs+(KSFB+Kcat) (12)

In this way, obtaining the upstream control air-fuel ratio abyfc and then calculating the main feedback amount DFi such that the upstream control air-fuel ratio abyfc coincides with the target air-fuel ratio abyfr that is kept at the stoichiometric air-fuel ratio stoich is equivalent to correcting the target air-fuel ratio abyfr using the sub-feedback amount KSFB and the catalyst state correction amount Kcat and then calculating the main feedback amount DFi such that the upstream air-fuel ratio abyfs coincides with the corrected target air-fuel ratio abyfr. In other words, increasing the target air-fuel ratio abyfr by an air-fuel ratio ΔAF is equivalent to keeping the target air-fuel ratio abyfr at a constant value and reducing the upstream air-fuel ratio abyfs that is used in main feedback control (the upstream air-fuel ratio abyfs that is used in step 720 of FIG. 7) by ΔAF.

That is, the feedback control unit according to the alternative embodiment executes air-fuel ratio feedback control by calculating a sensor output correction amount (sub-feedback amount KSFB) on the basis of the output (output value Voxs) of the downstream air-fuel ratio sensor 96 such that the output (output value Voxs) of the downstream air-fuel ratio sensor 96 coincides with the downstream target value Voxsref, acquiring the upstream control air-fuel ratio abyfc on the basis of the sensor output correction amount (sub-feedback amount KSFB) and the output (output value Vabyfs) of the upstream air-fuel ratio sensor 95 (see the above-described mathematical expression (11) or the mathematical expression (12)), and controlling the air-fuel ratio of the engine such that the upstream control air-fuel ratio abyfc coincides with the target air-fuel ratio (=stoichiometric air-fuel ratio stoich).

Furthermore, the feedback control unit according to the alternative embodiment is configured to acquire a learned value (sub-FB learned value KSFBg) by learning a sensor output correction amount (sub-feedback amount KSFB), and to use a value (sub-FB learned value KSFBg) based on the learned value as the sensor output correction amount (sub-feedback amount KSFB) for acquiring the upstream control air-fuel ratio abyfc at least in a period during which the sensor output correction amount (sub-feedback amount KSFB) cannot be updated on the basis of the output (output value Voxs) of the downstream air-fuel ratio sensor 96 (period during which the sub-feedback control condition is not satisfied).

The air-fuel ratio changing unit is configured to substantially change the target air-fuel ratio abyfr by correcting the upstream control air-fuel ratio abyfc (the upstream control air-fuel ratio abyfc that is obtained by applying the sum of the output value Vabyfs and the sub-feedback amount KSFB to the table Mapabyfs or the sum of the upstream air-fuel ratio abyfs and the sub-feedback amount KSFB) on the basis of the catalyst parameter (acquiring the upstream control air-fuel ratio abyfc by applying the control output value Vabyfc that is obtained by the above-described mathematical expression (11) to the table Mapabyfs or adding the catalyst state correction amount Kcat to the sum of the upstream air-fuel ratio abyfs and the sub-feedback amount KSFB as shown in the above-described mathematical expression (12)).

According to this alternative embodiment as well, the target air-fuel ratio abyfr is substantially corrected on the basis of the catalyst parameter immediately after a start of the engine 20 through intermittent operation, so it is less likely that the sensor output correction amount (sub-feedback amount KSFB) significantly deviates from the sensor output correction amount (sub-feedback amount KSFB) in the case where the state of the catalyst 29 is stable. Thus, it is possible to start learning the sensor output correction amount (sub-feedback amount KSFB) from the time point at which the engine 20 is started through intermittent operation, so the opportunity of learning does not reduce, and it is possible to early acquire an appropriate learned value (sub-FB learned value KSFBg).

The invention is not limited to the above-described embodiments and alternative embodiment; various alternative embodiments may be employed within the scope of the invention. For example, the first device and the second device may be used in combination. That is, the sum of the catalyst state correction amount Kcat that is acquired in step 950 of FIG. 9 and the catalyst state correction amount Kcat that is acquired in step 1020 of FIG. 10 may be acquired as a final catalyst state correction amount Kcat.

Furthermore, the hybrid vehicle 10 is not limited to the system according to the above-described embodiments; the hybrid vehicle 10 may have any system as long as the hybrid vehicle 10 is configured to generate driving torque in the drive shaft 53 with the use of the electric motor and the engine 20 and to stop and resume the operation of the engine 20 (intermittently operate the engine 20) in response to the operating state of the hybrid vehicle 10.

What is claimed is:

1. An air-fuel ratio control apparatus configured to control an air-fuel ratio of air-fuel mixture that is supplied to an internal combustion engine, the internal combustion engine being mounted on a hybrid vehicle as a driving source together with an electric motor, the internal combustion engine including a catalyst in an exhaust passage, the internal combustion engine intermittently repeating a stop and start of its operation in response to an operating state of the hybrid vehicle, comprising:
an upstream air-fuel ratio sensor configured to generate an output corresponding to an air-fuel ratio of exhaust gas flowing into the catalyst;
a downstream air-fuel ratio sensor configured to generate an output corresponding to an air-fuel ratio of exhaust gas flowing out from the catalyst;
a feedback control unit configured to execute air-fuel ratio feedback control of the internal combustion engine on the basis of the output of the upstream air-fuel ratio sensor and the output of the downstream air-fuel ratio sensor such that the air-fuel ratio of air-fuel mixture supplied to the internal combustion engine coincides with a target air-fuel ratio; and
an air-fuel ratio changing unit configured to acquire a catalyst parameter that indicates a state of the catalyst at the time point at which the internal combustion engine is started after the operation of the internal combustion engine is stopped in response to the operating state of the hybrid vehicle, and to change the air-fuel ratio of exhaust gas flowing into the catalyst by changing the target air-fuel ratio on the basis of an acquired catalyst parameter in a predetermined period after the time point at which the internal combustion engine is started.

2. The air-fuel ratio control apparatus according to claim 1, wherein the feedback control unit is configured to calculate a target air-fuel ratio correction amount on the basis of the output of the downstream air-fuel ratio sensor such that the output of the downstream air-fuel ratio sensor coincides with a downstream target value,
the feedback control unit is configured to correct the target air-fuel ratio on the basis of the target air-fuel ratio correction amount,
the feedback control unit is configured to execute the air-fuel ratio feedback control by controlling the air-fuel ratio of the internal combustion engine such that an upstream air-fuel ratio indicated by the output of the upstream air-fuel ratio sensor coincides with the corrected target air-fuel ratio,
the feedback control unit is configured to acquire a learned value by learning the target air-fuel ratio correction amount,
the feedback control unit is configured to use a value based on the learned value as the target air-fuel ratio correction amount in a period during which a condition that the target air-fuel ratio correction amount cannot be updated on the basis of the output of the downstream air-fuel ratio sensor is satisfied, and
the air-fuel ratio changing unit is configured to correct the target air-fuel ratio on the basis of the acquired catalyst parameter.

3. The air-fuel ratio control apparatus according to claim 1, wherein
the feedback control unit is configured to calculate a sensor output correction amount on the basis of the output of the downstream air-fuel ratio sensor such that the output of the downstream air-fuel ratio sensor coincides with a downstream target value,
the feedback control unit is configured to acquire an upstream control air-fuel ratio on the basis of the sensor output correction amount and the output of the upstream air-fuel ratio sensor,
the feedback control unit is configured to execute the air-fuel ratio feedback control by controlling the air-fuel ratio of the internal combustion engine such that the upstream control air-fuel ratio coincides with the target air-fuel ratio,
the feedback control unit is configured to acquire a learned value by learning the sensor output correction amount,
the feedback control unit is configured to use a value based on the learned value as the sensor output correction amount in a period during which a condition that the sensor output correction amount cannot be updated on the basis of the output of the downstream air-fuel ratio sensor is satisfied, and
the air-fuel ratio changing unit is configured to change the target air-fuel ratio by correcting the upstream control air-fuel ratio on the basis of the acquired catalyst parameter.

4. An air-fuel ratio control method for air-fuel mixture that is supplied to an internal combustion engine, the internal combustion engine being mounted on a hybrid vehicle as a driving source together with an electric motor, the internal combustion engine including a catalyst in an exhaust passage, the internal combustion engine intermittently repeating a stop and start of its operation in response to an operating state of the hybrid vehicle, comprising:
generating an output of an upstream air-fuel ratio corresponding to an air-fuel ratio of exhaust gas flowing into the catalyst;
generating an output of a downstream air-fuel ratio corresponding to an air-fuel ratio of exhaust gas flowing out from the catalyst;
executing feedback control over an air-fuel ratio of the internal combustion engine on the basis of the output of the upstream air-fuel ratio and the output of the downstream air-fuel ratio such that the air-fuel ratio of air-fuel mixture supplied to the internal combustion engine coincides with a target air-fuel ratio;
acquiring a catalyst parameter that indicates a state of the catalyst at the time point at which the internal combustion engine is started after the operation of the internal combustion engine is stopped in response to the operating state of the hybrid vehicle; and
changing the air-fuel ratio of exhaust gas flowing into the catalyst by changing the target air-fuel ratio on the basis of an acquired catalyst parameter in a predetermined period after the time point at which the internal combustion engine is started.
